(19) United States
(12) Patent Application Publication
(10) Pub. No.: US 2025/0266554 A1
(43) Pub. Date: Aug. 21, 2025

(54) POWER STORAGE DEVICE AND VEHICLE

(71) Applicant: TOYOTA JIDOSHA KABUSHIKI KAISHA, Toyota-shi (JP)

(72) Inventor: Nobuyasu NISHIKI, Toyokawa-shi (JP)

(73) Assignee: TOYOTA JIDOSHA KABUSHIKI KAISHA, Toyota-shi (JP)

(21) Appl. No.: 19/007,816

(22) Filed: Jan. 2, 2025

(30) Foreign Application Priority Data
Feb. 20, 2024 (JP) 2024-023824

(51) Int. Cl. H01M 50/249; B60L 50/60; B60L 50/64; H01M 50/209; H01M 50/242; H01M 50/271; H01M 50/289

(52) U.S. Cl. CPC H01M 50/249; B60L 50/64; B60L 50/66; H01M 50/209; H01M 50/242; H01M 50/271; H01M 50/289; H01M 2220/20

(57) ABSTRACT

A power storage device includes: a first power storage stack and a second power storage stack each including a plurality of power storage cells; a lower case having the first power storage stack and the second power storage stack disposed therein; a cross member extending along a predetermined direction and partitioning a region in the lower case; and an electrical connection member that electrically connects the first power storage stack and the second power storage stack. When viewed in a vertical direction, the electrical connection member at least partially overlaps with the cross member and extends along an extension direction of the cross member.

### CROSS REFERENCE TO RELATED APPLICATIONS

This nonprovisional application is based on Japanese Patent Application No. 2024-023824 filed on Feb. 20, 2024 with the Japan Patent Office, the entire contents of which are hereby incorporated by reference.

### BACKGROUND

### Field

The present disclosure relates to a power storage device and a vehicle including the power storage device.

### Description of the Background Art

As a conventional power storage device, Japanese Patent Laying-Open No. 2023-046945 discloses such a configuration that in an accommodation case accommodating a plurality of battery modules (power storage stacks), a cross member is disposed between the battery modules adjacent to each other, and a mount member supporting an upper case is provided on the cross member.

A damper is disposed between a portion of the upper case located on the mount member and a body. When a load is input from below the accommodation case, the load is input to the body through the cross member and the mount member. At this time, a part of the load is absorbed by the damper disposed in an input path from the upper case to the body, whereby the load input to the body can be reduced.

### SUMMARY

The plurality of power storage stacks accommodated in the accommodation case are electrically connected by electrical connection members. When a load is input from outside the accommodation case, the electrical connection members and the power storage stacks may interfere with each other.

The present disclosure has been made in view of the above-described problem, and an object of the present disclosure is to provide a power storage device in which interference between an electrical connection member and a power storage stack when a load is input from outside can be suppressed, and a vehicle including the power storage device.

A power storage device according to the present disclosure includes: a first power storage stack and a second power storage stack each including a plurality of power storage cells; a lower case having the first power storage stack and the second power storage stack disposed therein; a cross member extending along a predetermined direction and partitioning a region in the lower case; and an electrical connection member that electrically connects the first power storage stack and the second power storage stack. When viewed in a vertical direction, the electrical connection member at least partially overlaps with the cross member and extends along an extension direction of the cross member.

According to the above-described configuration, in a region where the cross member is fixed, the rigidity of the lower case is high. Therefore, when a load is input to the lower case from outside, deformation of surroundings of the cross member is suppressed. Thus, input of the load to a portion of the electrical connection member overlapping with the cross member and extending along the extension direction of the cross member can be suppressed. As a result, interference between the electrical connection member and the power storage stacks can be suppressed and a short circuit in the power storage stacks can be suppressed.

In the power storage device according to the present disclosure, in a direction orthogonal to the extension direction, a width of a portion of the electrical connection member overlapping with the cross member and extending along the extension direction of the cross member may be shorter than a width of the cross member.

According to the above-described configuration, the width of the portion of the electrical connection member overlapping with the cross member and extending along the extension direction of the cross member is shorter than the width of the cross member, whereby interference between the electrical connection member and the power storage stacks can be suppressed more suitably.

In the power storage device according to the present disclosure, in the extension direction, a length of a portion of the electrical connection member overlapping with the cross member and extending along the extension direction of the cross member may be shorter than a length of the cross member.

According to the above-described configuration, the length of the portion of the electrical connection member overlapping with the cross member and extending along the extension direction of the cross member is shorter than the length of the cross member, whereby interference between the electrical connection member and the power storage stacks can be suppressed more suitably.

In the power storage device according to the present disclosure, the cross member may be disposed between the first power storage stack and the second power storage stack. A portion of the electrical connection member overlapping with the cross member and extending along the extension direction of the cross member may be disposed between the first power storage stack and the second power storage stack.

According to the above-described configuration, even in a situation in which the portion of the electrical connection member overlapping with the cross member and extending along the extension direction of the cross member is disposed between the first power storage stack and the second power storage stack, deformation of surroundings of the cross member is suppressed, whereby interference of the electrical connection member with any of the first power storage stack and the second power storage stack can be suppressed.

The power storage device according to the present disclosure may further include a holding member fixed to the cross member to extend upward in the vertical direction from the cross member. The holding member may hold a portion of the electrical connection member overlapping with the cross member and extending along the extension direction of the cross member. The holding member may protrude more upward in the vertical direction than the first power storage stack and the second power storage stack.

According to the above-described configuration, when a load is input from the upper side of the power storage device, downward deformation of a region directly above the holding member can be suppressed. Thus, the electrical connection member can be protected.

In the power storage device according to the present disclosure, the holding member may include an insertion portion into which the portion of the electrical connection member overlapping with the cross member and extending along the extension direction of the cross member is inserted.

According to the above-described configuration, the electrical connection member is inserted into the insertion portion, whereby vibration of the electrical connection member can be suppressed.

In the power storage device according to the present disclosure, the holding member may include a projection on a surface that defines the insertion portion.

According to the above-described configuration, the projection is provided, whereby slipping-off of the electrical connection member from the insertion portion caused by vibration from outside can be suppressed.

The power storage device according to the present disclosure may include a cover member that covers the first power storage stack and the second power storage stack from an upper side in the vertical direction. The holding member may be in contact with the cover member.

According to the above-described configuration, the holding member is in contact with the cover member, whereby the holding member can be sandwiched between the cover member and the cross member and vibration of the holding member can be suppressed.

A vehicle according to the present disclosure includes: the above-described power storage device; and a vehicle frame member.

According to the above-described configuration, the vehicle includes the power storage device, whereby interference between the electrical connection member and the power storage stacks can be suppressed and a short circuit in the power storage stacks can be suppressed.

The vehicle according to the present disclosure may include a buffer member disposed in a gap between the cover member and the vehicle frame member. The buffer member may be disposed above the holding member.

According to the above-described configuration, a load transmitted to the vehicle frame member when the load is applied to the power storage device from outside can be reduced by the buffer member. Furthermore, when the power storage device is mounted on a vehicle main body, the power storage device is mounted such that the power storage device is pressed against the buffer member, whereby the holding member can be pressed against the cross member with the reaction force.

Thus, vibration of the holding member can be suppressed and vibration of the electrical connection member held by the holding member can also be suppressed.

The vehicle according to the present disclosure may include a protection cover that covers a part of the cover member from an upper side of the cover member such that a space is formed between the protection cover and the cover member. The protection cover may include a pair of side wall portions spaced apart from each other in the extension direction of the cross member. In this case, the holding member may be disposed below a lower surface of each of the pair of side wall portions.

According to the above-described configuration, a load from the protection cover allows the holding member to be pressed against the cross member through the cover member. Thus, vibration of the holding member can be suppressed.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic view of a vehicle according to a first embodiment.

FIG. 2 shows a state in which a power storage device according to the first embodiment is fixed to the vehicle.

FIG. 3 is a schematic exploded perspective view of the power storage device according to the first embodiment.

FIG. 4 is a schematic plan view showing an inside of the power storage device according to the first embodiment.

FIG. 5 is a schematic cross-sectional view taken along line V-V shown in FIG. 4.

FIG. 6 is a schematic cross-sectional view showing a structure of a cross member and its surroundings in a power storage device according to a second embodiment.

FIG. 7 is a schematic cross-sectional view showing a structure of a cross member and its surroundings in a power storage device in a vehicle according to a third embodiment.

FIG. 8 is a schematic cross-sectional view showing a structure of a cross member and its surroundings in a power storage device according to a fourth embodiment.

FIG. 9 is a schematic cross-sectional view showing a positional relationship between a protection cover of a vehicle and a holding member of a power storage device according to a fifth embodiment.

FIG. 10 is a schematic plan view showing an inside of a power storage device according to a sixth embodiment.

FIG. 11 is a schematic plan view showing an inside of a power storage device according to a seventh embodiment.

### DESCRIPTION OF THE PREFERRED EMBODIMENTS

Hereinafter, embodiments of the present disclosure will be described in detail with reference to the drawings. In the embodiments described below, the same or corresponding portions are denoted by the same reference characters in the drawings, and description thereof will not be repeated.

When the number, an amount, or the like is mentioned in an embodiment described below, the scope of the present disclosure is not necessarily limited to the number, the amount, or the like unless otherwise specified. Each constituent element in the embodiment below is not necessarily essential to the present disclosure unless otherwise specified. When there are a plurality of embodiments below, combination of features in the embodiments as appropriate is originally intended unless otherwise specified.

### First Embodiment

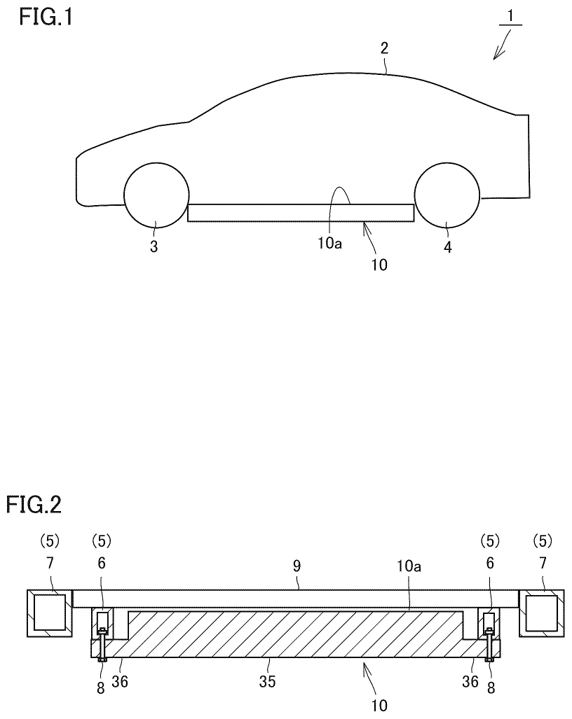

FIG. 1 is a schematic view of a vehicle according to a first embodiment. FIG. 2 shows a state in which a power storage device according to the first embodiment is fixed to the vehicle. A vehicle 1 according to the first embodiment will be described with reference to FIGS. 1 and 2.

Vehicle 1 is a hybrid vehicle that can travel using motive power of at least one of a motor and an engine, or an electrically powered vehicle that travels using driving force obtained by electrical energy.

Vehicle 1 includes a vehicle main body 2, a front wheel 3, a rear wheel 4, and a power storage device 10. Vehicle main body 2 includes a frame member 5. Power storage device 10 has an upper surface 10a. Upper surface 10a may also function as a floor member that defines a vehicle interior.

Frame member 5 includes a pair of side members 6 and a pair of side sills 7. The pair of side sills 7 are disposed at both ends in a width direction of vehicle 1. The pair of side members 6 are disposed inside the pair of side sills 7 with a distance therebetween. The pair of side members 6 and the pair of side sills 7 extend along a front-rear direction of vehicle 1.

The pair of side members 6 are spaced apart from each other in the width direction of vehicle 1. A main body portion 35 of power storage device 10 is disposed in a gap between the pair of side members 6. A void space is provided between main body portion 35 and the pair of side members 6. As a result, even when vehicle 1 experiences side collision, input of the impact to power storage device 10 can be suppressed.

Fixed portions 36 are provided on both side surfaces of main body portion 35 in the width direction of vehicle 1. Fixed portions 36 are fixed to the pair of side members 6 by fastening members 8, respectively.

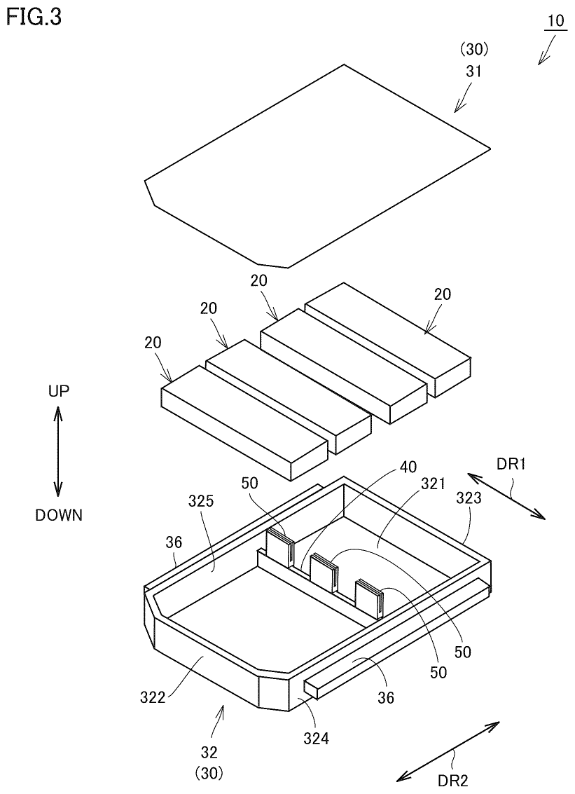

Frame member 5 also includes a vehicle-body-side cross member 9. Vehicle-body-side cross member 9 is provided above power storage device 10 to extend from one side sill 7 to the other side sill 7. Upper surface 10a of power storage device 10 is fixed to vehicle-body-side cross member 9. Upper surface 10a is configured by a cover member 31 described below (see FIG. 3).

Although the example in which frame member 5 includes the pair of side members 6 and the pair of side sills 7 has been illustrated and described above, the present disclosure is not limited thereto. The pair of side sills 7 may have the function of the pair of side members 6. In this case, the pair of side members 6 can be omitted and fixed portions 36 described above may be fixed to the pair of side sills 7.

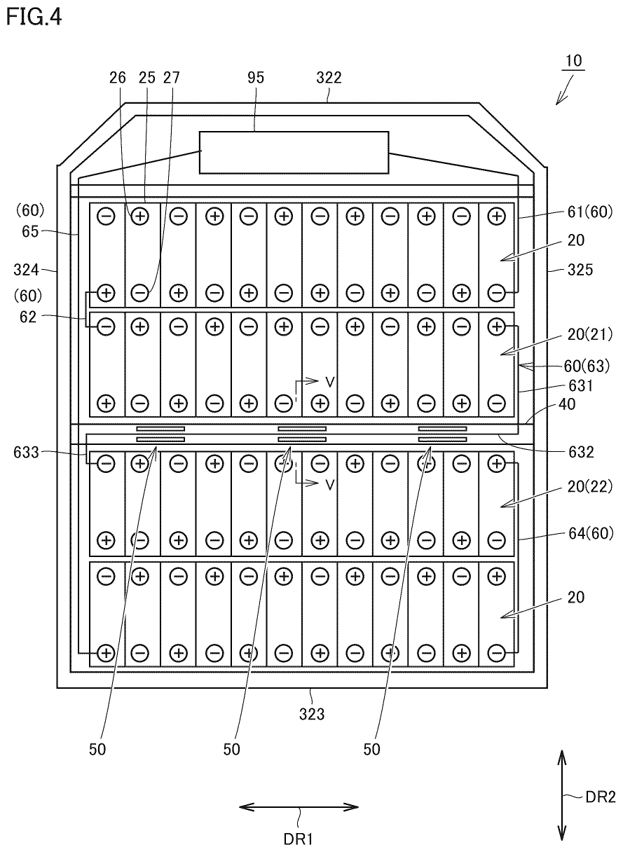

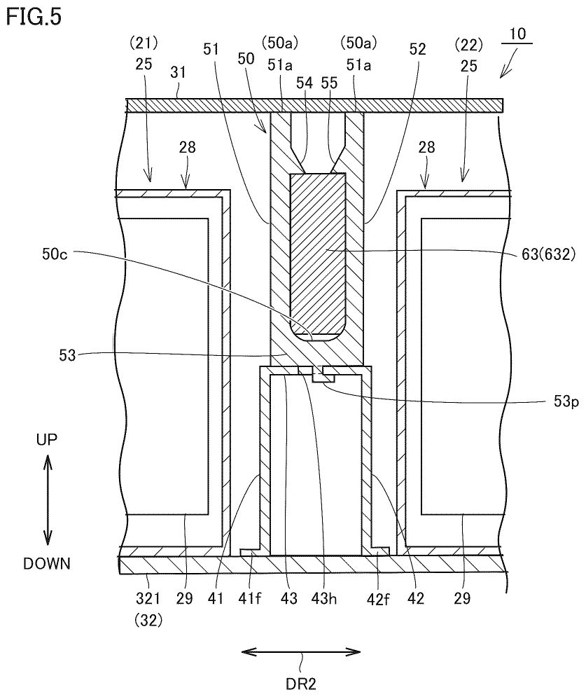

FIG. 3 is a schematic exploded perspective view of the power storage device according to the first embodiment. FIG. 4 is a schematic plan view showing an inside of the power storage device according to the first embodiment. Details of power storage device 10 will be described with reference to FIGS. 3 and 4. For the sake of convenience, the fixed portions shown in FIG. 3 are not shown in FIG. 4.

As shown in FIGS. 3 and 4, power storage device 10 includes a plurality of power storage stacks 20, an accommodation case 30, a cross member 40, a plurality of holding members 50, a plurality of electrical connection members 60, and an electronic device 95.

Each of the plurality of power storage stacks 20 includes a plurality of power storage cells 25. The plurality of power storage cells 25 are arranged in a first direction (DR1). In the present embodiment, the first direction is parallel to the width direction of vehicle 1 in a mounted state in which power storage device 10 is mounted on vehicle main body 2.

Each of power storage cells 25 is, for example, a secondary battery such as a nickel-metal hydride battery or a lithium ion battery. Each of power storage cells 25 may be a power storage cell including a liquid electrolyte, or may be a power storage cell including a solid electrolyte. Each of power storage cells 25 may be a chargeable and dischargeable capacitor.

Specifically, each of power storage cells 25 includes a housing 28 (see FIG. 5) and an electrode assembly 29 (see FIG. 5). Electrode assembly 29 is accommodated in housing 28. Electrode assembly 29 may be a stacked electrode assembly in which a negative electrode sheet, a separator and a positive electrode sheet are stacked, or may be a wound electrode assembly in which a negative electrode sheet, a separator and a positive electrode sheet are wound.

Each of power storage cells 25 includes a positive electrode external terminal 26 and a negative electrode external terminal 27. In each of power storage stacks 20, the plurality of power storage cells 25 are connected in series by a bus bar. The plurality of power storage cells 25 are disposed such that positive electrode external terminals 26 and negative electrode external terminals 27 are alternately arranged side by side in the first direction. In each of power storage stacks 20, the plurality of power storage cells 25 are arranged.

The plurality of power storage stacks 20 are arranged side by side in a second direction (DR2). The second direction is a direction orthogonal to the first direction.

In the present embodiment, the second direction is parallel to the front-rear direction of vehicle 1 in the above-described mounted state.

Accommodation case 30 includes a cover member 31 and a lower case 32. Lower case 32 has a substantially box shape that is opened upward. The plurality of power storage stacks 20 are disposed in lower case 32.

Lower case 32 includes main body portion 35 and fixed portions 36. Main body portion 35 has a bottom wall portion 321, a first wall portion 322, a second wall portion 323, and side wall portions 324 and 325. First wall portion 322, second wall portion 323, and side wall portions 324 and 325 are provided to rise from a perimeter edge of bottom wall portion 321.

First wall portion 322 and second wall portion 323 face each other in the second direction. Side wall portions 324 and 325 face each other in the first direction. Fixed portions 36 are provided on outer surfaces of side wall portions 324 and 325.

Cover member 31 has a substantially flat plate shape. Cover member 31 covers the plurality of power storage stacks 20 and closes an open space of lower case 32. A sealing member may be filled into a gap between cover member 31 and power storage stacks 20. The sealing member may have insulating properties. Cover member 31 may have the function as a floor panel, in addition to the function as a lid member that closes the open space of lower case 32 as described above.

Cross member 40 is fixed to lower case 32. Cross member 40 is made of, for example, a metal member such as SUS. Cross member 40 extends along a predetermined direction and partitions a region in lower case 32. Specifically, cross member 40 extends along the first direction. Cross member 40 divides the region in lower case 32 into two regions and two power storage stacks 20 are disposed in each divided region.

The plurality of power storage stacks 20 described above include a first power storage stack 21 and a second power storage stack 22 spaced apart from each other in the second direction. First power storage stack 21 and second power storage stack 22 are disposed to be adjacent to each other in the second direction, and cross member 40 is disposed in a gap between first power storage stack 21 and second power storage stack 22.

The plurality of holding members 50 are fixed to cross member 40 to extend upward in a vertical direction from cross member 40. The vertical direction is a direction orthogonal to the above-described first and second directions. The plurality of holding members 50 are spaced apart from each other in the first direction.

Electronic device 95 is disposed on one side in the second direction relative to the plurality of power storage stacks 20. Electronic device 95 is a battery ECU (Electronic Control Unit), for example.

The plurality of electrical connection members 60 electrically connect, in series, the plurality of power storage stacks 20 arranged side by side in the second direction. The plurality of electrical connection members 60 include electrical connection members 61, 62, 63, 64, and 65.

Electrical connection member 61 connects a negative electrode in a battery module configured by a plurality of power storage stacks 20 and electronic device 95 to each other, for example. Electrical connection member 62 electrically connects, in series, two power storage stacks 20 disposed in a region located on one side in the second direction relative to cross member 40.

Electrical connection member 63 electrically connects above-described first power storage stack 21 and second power storage stack 22 to each other. More particularly, electrical connection member 63 electrically connects a first power storage module configured by two power storage stacks 20 disposed in the region located on one side in the second direction relative to cross member 40 and a second power storage module configured by two power storage stacks 20 disposed in a region located on the other side in the second direction relative to cross member 40.

When viewed in the vertical direction, electrical connection member 63 at least partially overlaps with cross member 40 and extends along an extension direction of cross member 40. Specifically, electrical connection member 63 has a first routing portion 631, an overlapping portion 632 and a second routing portion 633. First routing portion 631 extends from first power storage stack 21 toward cross member 40 along the first direction.

Overlapping portion 632 is a portion of electrical connection member 63 overlapping with cross member 40 and extending along the extension direction of cross member 40 when viewed in the vertical direction. In a direction orthogonal to the extension direction, a width of overlapping portion 632 is shorter than a width of cross member 40. In the above-described extension direction, a length of overlapping portion 632 is shorter than a length of cross member 40.

Second routing portion 633 extends toward second power storage stack 22 along the first direction on a side opposite to a side where first routing portion 631 is located in the first direction.

Electrical connection member 64 electrically connects, in series, two power storage stacks 20 disposed in the region located on the other side in the second direction relative to cross member 40. Electrical connection member 65 connects a positive electrode in a battery module configured by a plurality of power storage stacks 20 and electronic device 95 to each other, for example.

FIG. 5 is a schematic cross-sectional view taken along line V-V shown in FIG. 4. Details of cross member 40 and holding member 50 will be described with reference to FIG. 5.

As shown in FIG. 5, cross member 40 has a hollow structure. Cross member 40 includes a pair of side wall portions 41 and 42, and an upper wall portion 43. The pair of side wall portions 41 and 42 face each other in the direction in which first power storage stack 21 and second power storage stack 22 are arranged side by side, i.e., the second direction.

Side wall portion 41 is located on the first power storage stack 21 side. A flange portion 41f extending toward the first power storage stack 21 side is provided at a lower end of side wall portion 41. Side wall portion 42 is located on the second power storage stack 22 side. A flange portion 42f extending toward the second power storage stack 22 side is provided at a lower end of side wall portion 42.

Above-described flange portions 41f and 42f are fixed to bottom wall portion 321 of lower case 32 by welding, fastening or the like, whereby cross member 40 is fixed to lower case 32.

Upper wall portion 43 connects upper ends of the pair of side wall portions 41 and 42 to each other. A through hole 43h is provided in upper wall portion 43. An engagement portion 53p described below is inserted into through hole 43h.

Holding member 50 holds above-described overlapping portion 632. Holding member 50 has an insertion portion 50c into which overlapping portion 632 is inserted. Overlapping portion 632 is inserted into insertion portion 50c, whereby overlapping portion 632 is held. “Overlapping portion 632 is held” is not limited to a state in which overlapping portion 632 is maintained in contact with a surface of holding member 50 that defines insertion portion 50c, and also means that overlapping portion 632 is separated from the surface and located within insertion portion 50c. That is, “overlapping portion 632 is held” means that a state in which overlapping portion 632 is located within a space partitioned by the surface of holding member 50 that defines insertion portion 50c is maintained. An upper end 50a of holding member 50 abuts on cover member 31. Thus, vibration of holding member 50 can be suppressed.

Holding member 50 has a substantially U shape. Holding member 50 has a pair of wall portions 51 and 52 that face each other in the second direction, and a bottom portion 53. The pair of wall portions 51 and 52 are spaced apart from each other in the second direction. The pair of wall portions 51 and 52 are provided to protrude upward from both ends of bottom portion 53 in the second direction. Above bottom portion 53, a space is formed between the pair of wall portions 51 and 52, and this space constitutes above-described insertion portion 50c.

A part of overlapping portion 632 is inserted into the space between the pair of wall portions 51 and 52, and overlapping portion 632 is sandwiched between the pair of wall portions 51 and 52. Thus, vibration of overlapping portion 632 can be suppressed. In addition, projections 54 and 55 are provided on the inner surface of holding member 50 that defines insertion portion 50c. Projections 54 and 55 are spaced apart from each other in the second direction. Projection 54 is provided on an inner surface of one wall portion 51 of the pair of wall portions 51, and projection 55 is provided on an inner surface of the other wall portion 52 of the pair of wall portions 51.

Projections 54 and 55 are disposed above overlapping portion 632 in a state where overlapping portion 632 is inserted into insertion portion 50c. Thus, upward slipping-off of overlapping portion 632 can be suppressed.

Projections 54 and 55 may press overlapping portion 632 downward, whereby overlapping portion 632 may be sandwiched between projections 54 and 55 and bottom portion 53. In this case as well, vibration of overlapping portion 632 can be suppressed.

Upper ends 51a and 52a of the pair of wall portions 51 and 52 abut on cover member 31. The load of cover member 31 is received by the pair of wall portions 51 and 52, whereby opening of the pair of wall portions 51 and 52 can be suppressed. Using this load, above-described projections 54 and 55 may press overlapping portion 632 against bottom portion 53.

In the above-described inserted state, a gap may be provided between projections 54 and 55 and overlapping portion 632. In this case, transmission of a load to overlapping portion 632 when the load such as impact is applied from the upper side of cover member 31 can be suppressed. Thus, breakage of overlapping portion 632 can be suppressed.

Engagement portion 53p protruding downward is provided on a lower surface of bottom portion 53. Engagement portion 53p engages with a portion of above-described upper wall portion 43 located at a circumferential edge of through hole 43h, in a state where engagement portion 53p is inserted into through hole 43h provided in cross member 40. Thus, holding member 50 is fixed to cross member 40. With such a configuration, holding member 50 can be easily fixed. Holding member 50 may be fixed to cross member 40 by welding, fastening or the like.

Electrical connection member 63 is configured by a bus bar. In the present embodiment, electrical connection member 63 is configured by a metal member and holding member 50 is configured by an insulating member. The other electrical connection members may be configured similarly to electrical connection member 63.

As described above, in power storage device 10 according to the first embodiment, cross member 40 is provided between first power storage stack 21 and second power storage stack 22 adjacent to each other in the second direction, and electrical connection member 63 that connects first power storage stack 21 and second power storage stack 22 includes overlapping portion 632 overlapping with cross member 40 and extending along the extension direction of cross member 40 when viewed in the vertical direction.

In the region where cross member 40 is fixed, the rigidity of lower case 32 is high. Therefore, when a load is input to lower case 32 from outside, deformation of surroundings of cross member 40 is suppressed. For example, when vehicle 1 experiences side collision and the impact is input in the width direction (first direction) of the vehicle, cross member 40 receives the impact. Therefore, in the region where cross member 40 is disposed, inward deformation of the side wall portions of lower case 32 is suppressed and deformation of cross member 40 itself is also suppressed. Thus, input of the load to overlapping portion 632 extending along the extension direction of cross member 40 and overlapping with cross member 40 can be suppressed. As a result, interference between electrical connection member 63 and first and second power storage stacks 21 and 22 can be suppressed and a short circuit in first power storage stack 21 and second power storage stack 22 can be suppressed.

When vehicle 1 experiences front collision or rear collision and the impact is input in the front-rear direction (first direction) of vehicle 1, a reduction of the gap between first power storage stack 21 and second power storage stack 22 is suppressed due to the inertia. Thus, it is also possible to suppress a situation in which overlapping portion 632 overlapping with cross member 40 disposed in the gap between first power storage stack 21 and second power storage stack 22 is sandwiched between first power storage stack 21 and second power storage stack 22. As a result, interference between electrical connection member 63 and first and second power storage stacks 21 and 22 can be suppressed and a short circuit in first power storage stack 21 and second power storage stack 22 can be suppressed.

Furthermore, since the width of overlapping portion 632 is shorter than the width of cross member 40 as described above, interference between electrical connection member 63 and first and second power storage stacks 21 and 22 can be suppressed more effectively.

In addition, since the length of overlapping portion 632 along the extension direction of cross member 40 is shorter than the length of cross member 40 as described above, hitting of the side wall portions of lower case 32 against electrical connection member 63 when vehicle 1 experiences side collision can be suppressed. As a result, interference between electrical connection member 63 and first and second power storage stacks 21 and 22 can be suppressed more effectively.

### Second Embodiment

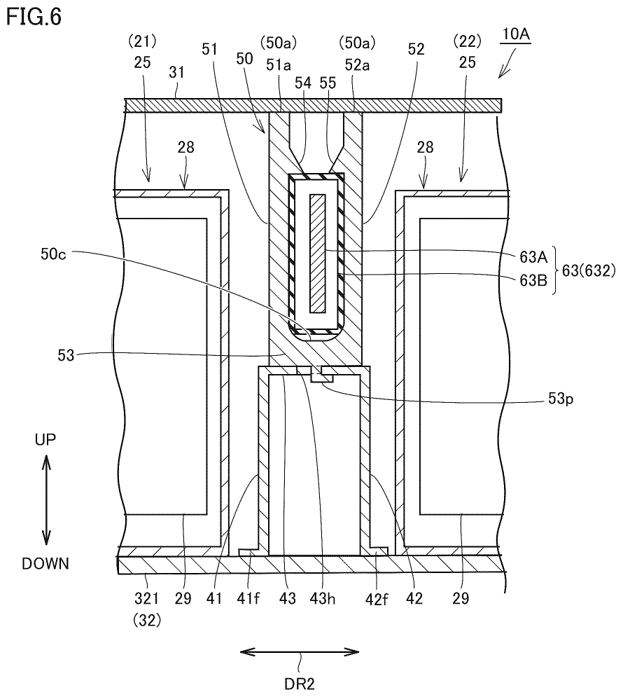

FIG. 6 is a schematic cross-sectional view showing a structure of a cross member and its surroundings in a power storage device according to a second embodiment. A power storage device 10A according to the second embodiment will be described with reference to FIG. 6.

As shown in FIG. 6, power storage device 10A according to the second embodiment is different from power storage device 10 according to the first embodiment in terms of the configuration of electrical connection member 63. Power storage device 10A according to the second embodiment is otherwise substantially the same as power storage device 10 according to the first embodiment.

Electrical connection member 63 includes an electrically conductive member 63A and a protection member 63B. Protection member 63B is configured by an insulating member and has a hollow structure. Electrically conductive member 63A is disposed in a hollow portion of protection member 63B. Electrically conductive member 63A is separated from protection member 63B and disposed within protection member 63B. That is, a gap is formed between protection member 63B and electrically conductive member 63A. The other electrical connection members may also be configured similarly to electrical connection member 63.

With the above-described configuration as well, power storage device 10A according to the second embodiment can obtain substantially the same effect as that of the first embodiment. Since electrically conductive member 63A is separated from protection member 63B, transmission of a load applied to protection member 63B to electrically conductive member 63A can be suppressed. As a result, breakage of electrically conductive member 63A can be suppressed and interference between electrical connection member 63 and first and second power storage stacks 21 and 22 can be suppressed more effectively. Furthermore, since protection member 63B is held by holding member 50, protection member 63B also functions as a strut that supports cover member 31. As a result, deformation of cover member 31 or bottom wall portion 321 when a load is applied from the upper side of cover member 31 or from the lower side of bottom wall portion 321 can be suppressed.

### Third Embodiment

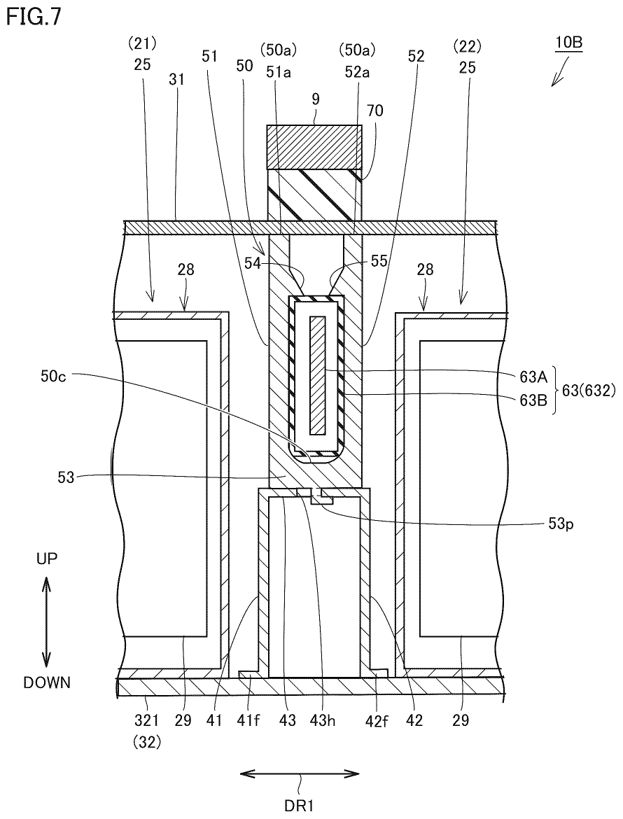

FIG. 7 is a schematic cross-sectional view showing a structure of a cross member and its surroundings in a power storage device in a vehicle according to a third embodiment. A power storage device 10B according to the third embodiment will be described with reference to FIG. 7.

As shown in FIG. 7, the vehicle according to the third embodiment is different from a vehicle including power storage device 10A according to the second embodiment in that the vehicle according to the third embodiment includes a buffer member 70 between vehicle main body 2 and cover member 31. The vehicle according to the third embodiment is otherwise substantially the same as the vehicle including power storage device 10A according to the second embodiment.

Above holding member 50, buffer member 70 is sandwiched between frame member 5 and cover member 31. More particularly, buffer member 70 is disposed between vehicle-body-side cross member 9 and cover member 31.

With the above-described configuration as well, the vehicle according to the third embodiment can obtain substantially the same effect as that of the vehicle including power storage device 10A according to the second embodiment. In addition, since the vehicle according to the third embodiment includes buffer member 70, a load transmitted to the vehicle frame member when the load is applied to power storage device 10B from outside can be reduced by the buffer member. In addition, when power storage device 10B is mounted on vehicle main body 2, power storage device 10B is mounted such that power storage device 10B is pressed against buffer member 70, whereby holding member 50 can be pressed against cross member 40 with the reaction force. Thus, vibration of holding member 50 can be suppressed and vibration of overlapping portion 632 held by holding member 50 can also be suppressed.

### Fourth Embodiment

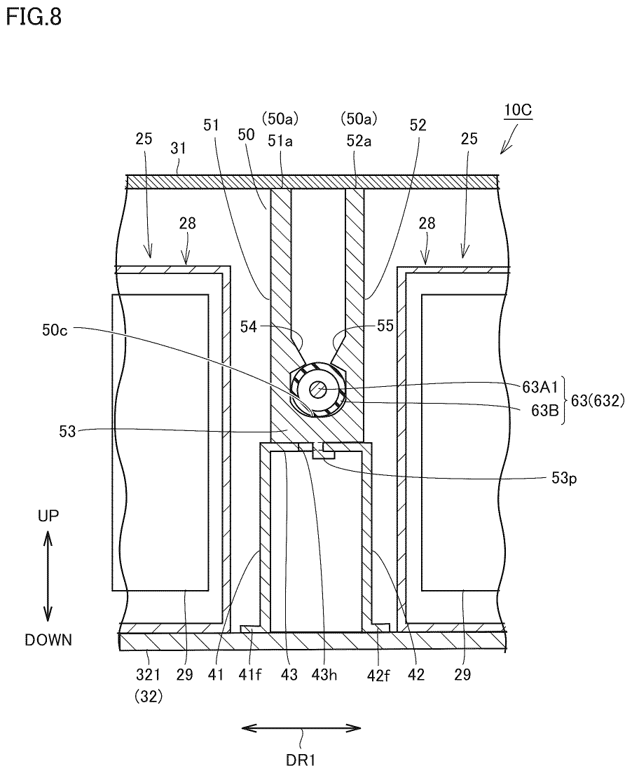

FIG. 8 is a schematic cross-sectional view showing a structure of a cross member and its surroundings in a power storage device according to a fourth embodiment. A power storage device 10C according to the fourth embodiment will be described with reference to FIG. 8.

As shown in FIG. 8, power storage device 10C according to the fourth embodiment is different from power storage device 10A according to the second embodiment mainly in terms of the configuration of electrical connection member 63. Power storage device 10C according to the fourth embodiment is otherwise substantially the same as power storage device 10A according to the second embodiment.

Electrical connection member 63 includes a wire portion 63A1 and protection member 63B. In the present embodiment as well, protection member 63B is configured by an insulating member and has a hollow structure. Wire portion 63A1 is disposed in a hollow portion of protection member 63B. A gap is formed between protection member 63B and wire portion 63A1. Wire portion 63A1 has a substantially columnar shape and protection member 63B has a substantially cylindrical shape. Wire portion 63A1 is configured by a wire harness, for example. Overlapping portion 632 of electrical connection member 63 is sandwiched between the pair of projections 54 and 55 and bottom portion 53.

With the above-described configuration as well, power storage device 10C according to the third embodiment can obtain substantially the same effect as that of power storage device 10A according to the second embodiment.

### Fifth Embodiment

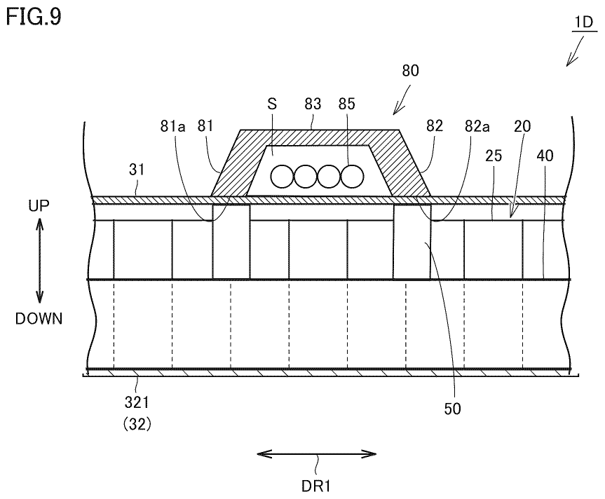

FIG. 9 is a schematic cross-sectional view showing a positional relationship between a protection cover of a vehicle and a holding member of a power storage device according to a fifth embodiment. A vehicle 1D according to the fifth embodiment will be described with reference to FIG. 9.

As shown in FIG. 9, vehicle 1D according to the fifth embodiment is different from vehicle 1 according to the first embodiment in terms of a protection cover 80 and a wire 85, and the position of holding member 50. Vehicle 1D according to the fifth embodiment is otherwise substantially the same as vehicle 1 according to the first embodiment.

Protection cover 80 protects wire 85 routed above cover member 31. Protection cover 80 covers a part of cover member 31 from the upper side of cover member 31 such that a space S is formed between protection cover 80 and cover member 31. Wire 85 is located within space S. Protection cover 80 is disposed to overlap with a part of cross member 40 when viewed in the vertical direction. For example, protection cover 80 is disposed to overlap with a central portion of cross member 40 in the extension direction of cross member 40 when viewed in the vertical direction. Protection cover 80 extends along a direction intersecting the above-described extension direction. Specifically, protection cover 80 extends along the second direction.

Protection cover 80 has a pair of side wall portions 81 and 82 and a ceiling portion 83. The pair of side wall portions 81 and 82 are spaced apart from each other in the extension direction of cross member 40. The pair of side wall portions 81 and 82 have lower surfaces 81a and 82a, respectively. Ceiling portion 83 connects upper ends of the pair of side wall portions 81 and 82 to each other.

Holding members 50 are disposed below lower surfaces 81a and 82a of the pair of side wall portions 81 and 82, respectively. Below lower surfaces 81a and 82a, holding members 50 are sandwiched between cover member 31 and cross member 40.

With the above-described configuration as well, the vehicle according to the fifth embodiment can obtain substantially the same effect as that of vehicle 1 including power storage device 10 according to the first embodiment. In addition, since holding members 50 are disposed below lower surfaces 81a and 82a of the pair of side wall portions 81 and 82, respectively, a load from protection cover 80 allows holding members 50 to be pressed against cross member 40 through cover member 31. Thus, vibration of holding member 50 can be suppressed.

### Sixth Embodiment

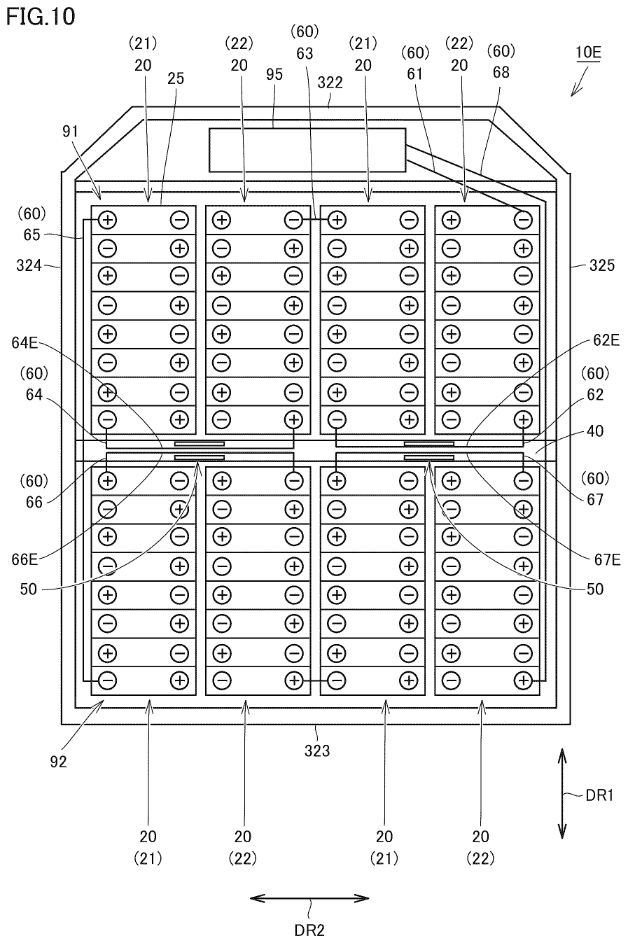

FIG. 10 is a schematic plan view showing an inside of a power storage device according to a sixth embodiment. A power storage device 10E according to the sixth embodiment will be described with reference to FIG. 10.

As shown in FIG. 10, power storage device 10E according to the sixth embodiment is different from power storage device 10 according to the first embodiment mainly in terms of the arrangement of the plurality of power storage stacks 20 and the routing path of electrical connection member 60. Power storage device 10E according to the sixth embodiment is otherwise substantially the same as power storage device 10 according to the first embodiment.

In the present embodiment, the first direction in which the plurality of power storage cells 25 are arranged is parallel to the front-rear direction of the vehicle, and the second direction orthogonal to the first direction is parallel to the width direction of the vehicle.

The plurality of power storage stacks 20 are disposed in a matrix shape. For example, the plurality of power storage stacks 20 are disposed in a matrix with 4 rows and 2 columns, in which the first direction is a row direction and the second direction orthogonal to the first direction is a column direction. More particularly, when one power storage unit is formed by arranging, side by side in the above-described second direction, four power storage stacks 20 each including the plurality of power storage cells 25 arranged in the first direction, a first power storage unit 91 and a second power storage unit 92 are spaced apart from each other and arranged side by side in the first direction. Each of power storage stacks 20 includes the even number of power storage cells 25.

Each of first power storage unit 91 and second power storage unit 92 has two sets of first power storage stack 21 and second power storage stack 22 disposed in the second direction to be adjacent to each other.

Cross member 40 is disposed in a gap between first power storage unit 91 and second power storage unit 92. Cross member 40 extends along the second direction.

The plurality of electrical connection members 60 include electrical connection members 61, 62, 63, 64, 65, 66, 67, and 68, and electrically connect the plurality of power storage stacks 20 in series.

Each of electrical connection members 62, 64, 66, and 67 connects first power storage stack 21 and second power storage stack 22 adjacent to each other.

Specifically, electrical connection member 62 electrically connects one set of first power storage stack 21 and second power storage stack 22, of two sets of first power storage stack 21 and second power storage stack 22 included in first power storage unit 91. Electrical connection member 64 electrically connects the other set of first power storage stack 21 and second power storage stack 22, of two sets of first power storage stack 21 and second power storage stack 22 included in first power storage unit 91.

Electrical connection member 66 electrically connects one set of first power storage stack 21 and second power storage stack 22, of two sets of first power storage stack 21 and second power storage stack 22 included in second power storage unit 92. Electrical connection member 67 electrically connects the other set of first power storage stack 21 and second power storage stack 22, of two sets of first power storage stack 21 and second power storage stack 22 included in second power storage unit 92.

Electrical connection members 62, 64, 66, and 67 have overlapping portions 62E, 64E, 66E, and 67E overlapping with cross member 40 and extending along the extension direction of cross member 40, respectively, when viewed in the vertical direction.

Two holding members 50 are spaced apart from each other and arranged side by side in the second direction, for example. One holding member 50 of two holding members 50 holds overlapping portions 62E and 67E, and the other holding member 50 of two holding members 50 holds overlapping portions 64E and 66E.

In the present embodiment, two sets of first power storage stack 21 and second power storage stack 22 are arranged side by side in two rows in the first direction, and the electrical connection members that electrically connect the respective sets of first power storage stack 21 and second power storage stack 22 are held by one common holding member 50.

With the above-described configuration as well, power storage device 10E according to the sixth embodiment can obtain substantially the same effect as that of power storage device 10 according to the first embodiment.

### Seventh Embodiment

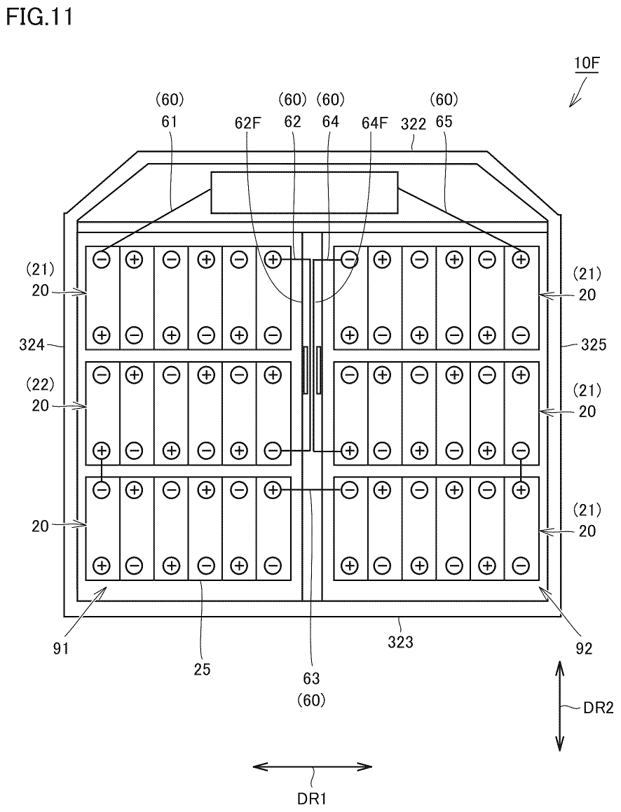

FIG. 11 is a schematic plan view showing an inside of a power storage device according to a seventh embodiment. A power storage device 10F according to the seventh embodiment will be described with reference to FIG. 11.

As shown in FIG. 11, power storage device 10F according to the seventh embodiment is different from power storage device 10 according to the first embodiment mainly in terms of the arrangement of the plurality of power storage stacks 20, the arrangement of cross member 40, and the routing path of electrical connection member 60. Power storage device 10F according to the seventh embodiment is otherwise substantially the same as power storage device 10 according to the first embodiment.

In the present embodiment, the first direction in which the plurality of power storage cells 25 are arranged is parallel to the width direction of the vehicle, and the second direction orthogonal to the first direction is parallel to be front-rear direction of the vehicle.

The plurality of power storage stacks 20 are disposed in a matrix shape. For example, the plurality of power storage stacks 20 are disposed in a matrix with 3 rows and 2 columns, in which the first direction is a column direction and the second direction orthogonal to the first direction is a row direction.

More particularly, when one power storage unit is formed by arranging, side by side in the above-described second direction, three power storage stacks 20 each including the plurality of power storage cells 25 arranged in the first direction, first power storage unit 91 and second power storage unit 92 are spaced apart from each other and arranged side by side in the first direction. Each of power storage stacks 20 includes the even number of power storage cells 25.

Each of first power storage unit 91 and second power storage unit 92 has one set of first power storage stack 21 and second power storage stack 22 disposed in the second direction to be adjacent to each other.

Cross member 40 is disposed in a gap between first power storage unit 91 and second power storage unit 92. Cross member 40 extends along the second direction.

The plurality of electrical connection members 60 include electrical connection members 61, 62, 63, 64, and 65, and electrically connect the plurality of power storage stacks 20 in series.

Each of electrical connection members 62 and 64 connects first power storage stack 21 and second power storage stack 22 adjacent to each other.

Specifically, electrical connection member 62 electrically connects first power storage stack 21 and second power storage stack 22 included in first power storage unit 91. Electrical connection member 64 electrically connects first power storage stack 21 and second power storage stack 22 included in second power storage unit 92.

Electrical connection members 62 and 64 have overlapping portions 62F and 64F overlapping with cross member 40 and extending along the extension direction of cross member 40, respectively, when viewed in the vertical direction.

In the present embodiment as well, two sets of first power storage stack 21 and second power storage stack 22 are arranged side by side in two rows in the first direction, and the electrical connection members that electrically connect the respective sets of first power storage stack 21 and second power storage stack 22 are held by one common holding member 50.

With the above-described configuration as well, power storage device 10F according to the seventh embodiment can obtain substantially the same effect as that of power storage device 10 according to the first embodiment.

Although the embodiments of the present disclosure have been described, it should be understood that the embodiments disclosed herein are illustrative and non-restrictive in every respect. The scope of the present disclosure is defined by the terms of the claims, and is intended to include any modifications within the scope and meaning equivalent to the terms of the claims.

What is claimed is:

1. A power storage device comprising:
a first power storage stack and a second power storage stack each including a plurality of power storage cells;
a lower case having the first power storage stack and the second power storage stack disposed therein;
a cross member extending along a predetermined direction and partitioning a region in the lower case; and
an electrical connection member that electrically connects the first power storage stack and the second power storage stack, wherein
when viewed in a vertical direction, the electrical connection member at least partially overlaps with the cross member and extends along an extension direction of the cross member.

2. The power storage device according to claim 1, wherein
in a direction orthogonal to the extension direction, a width of a portion of the electrical connection member overlapping with the cross member and extending along the extension direction of the cross member is shorter than a width of the cross member.

3. The power storage device according to claim 1, wherein
in the extension direction, a length of a portion of the electrical connection member overlapping with the cross member and extending along the extension direction of the cross member is shorter than a length of the cross member.

4. The power storage device according to claim 1, wherein
the cross member is disposed between the first power storage stack and the second power storage stack, and
a portion of the electrical connection member overlapping with the cross member and extending along the extension direction of the cross member is disposed between the first power storage stack and the second power storage stack.

5. The power storage device according to claim 1, further comprising
a holding member fixed to the cross member to extend upward in the vertical direction from the cross member, wherein
the holding member holds a portion of the electrical connection member overlapping with the cross member and extending along the extension direction of the cross member, and
the holding member protrudes more upward in the vertical direction than the first power storage stack and the second power storage stack.

6. The power storage device according to claim 5, wherein
the holding member includes an insertion portion into which the portion of the electrical connection member overlapping with the cross member and extending along the extension direction of the cross member is inserted.

7. The power storage device according to claim 6, wherein
the holding member includes a projection on a surface that defines the insertion portion.

8. The power storage device according to claim 5, comprising
a cover member that covers the first power storage stack and the second power storage stack from an upper side in the vertical direction, wherein
the holding member is in contact with the cover member.

9. A vehicle comprising:
the power storage device as recited in claim 8; and
a vehicle frame member.

10. The vehicle according to claim 9, comprising
a buffer member disposed in a gap between the cover member and the vehicle frame member, wherein
the buffer member is disposed above the holding member.

11. The vehicle according to claim 9, comprising
a protection cover that covers a part of the cover member from an upper side of the cover member such that a space is formed between the protection cover and the cover member, wherein
the protection cover includes a pair of side wall portions spaced apart from each other in the extension direction of the cross member, and
the holding member is disposed below a lower surface of each of the pair of side wall portions.
